(19) United States
(12) Patent Application Publication
(10) Pub. No.: US 2025/0283747 A1
(43) Pub. Date: Sep. 11, 2025

(54) Liquid Level Measurement Device, Method and Apparatus, Storage Medium and 3D Printer

(71) Applicant: GUANGZHOU HEYGEARS IMC. INC, Guangzhou (CN)

(72) Inventors: Mingjie XU, Guangzhou (CN); Ming LUO, Guangzhou (CN); Weibin ZENG, Guangzhou (CN)

(73) Assignee: GUANGZHOU HEYGEARS IMC. INC, Guangzhou (CN)

(21) Appl. No.: 19/217,561

(22) Filed: May 23, 2025

Related U.S. Application Data
(63) Continuation-in-part of application No. PCT/CN2023/131084, filed on Nov. 10, 2023.

(30) Foreign Application Priority Data
Nov. 24, 2022 (CN) 202211485222.8
Nov. 24, 2022 (CN) 202223134944.7

(51) Int. Cl. G01F 23/263; B33Y 50/00

(52) U.S. Cl. CPC G01F 23/266; B33Y 50/00

(57) ABSTRACT

Disclosed in the present disclosure are a liquid level measurement device, method and apparatus, a storage medium, and a 3D printer, relating to the technical field of liquid level measurement. The liquid level measurement device comprises: a first excitation circuit, configured to output a first voltage signal according to a first excitation signal and a current liquid level; a first detection circuit, configured to extract a peak voltage of the first voltage signal; and a comparison and amplification circuit, configured to output a second voltage signal according to the peak voltage and a first preset reference voltage, wherein the second voltage signal is configured to represent a height corresponding to the current liquid level. Small space is occupied, and the detection accuracy is high.

The present disclosure claims priority to Chinese Patent Application no. 202211485222.8, to the China National Intellectual Property Administration on 24 Nov. 2022 and entitled “Liquid Level Measurement Device, Method and Apparatus, Storage Medium and 3D Printer”, and Chinese Patent Application no. 202223134944.7, to the China National Intellectual Property Administration on 24 Nov. 2022 and entitled “Liquid Level Measurement Device and 3D Printer”, which are incorporated herein by reference in its entirety.

### TECHNICAL FIELD

The present disclosure relates to the technical field of liquid level measurement, and in particular to a liquid level measurement device, method and apparatus, and a storage medium.

### BACKGROUND

Conventional liquid level measurement devices include hydraulic measurement devices, floating ball type measurement devices, ultrasonic measurement devices, etc., and have problems of occupying a large volume, having low measurement precision, or having high construction costs. For example, in 3D printing based on UV curing, the liquid level of the liquid photosensitive resin material needs to be measured. As a non-conductive liquid material, photosensitive resin renders conventional measurement methods based on changes in connectivity due to liquid conductivity inapplicable. However, the hydraulic measurement devices, the floating ball type measurement devices, the ultrasonic measurement devices, etc. are unsuitable for cost-sensitive 3D printing equipment due to occupying the large volume, having the low measurement precision, or having the high construction costs. The laser type measurement devices have the advantage of being non-contact, however, they cannot measure the liquid level of transparent resin and thus lack versatility.

Therefore, how to design a liquid level measurement device with low cost and high measurement accuracy is a technical problem to be solved.

Furthermore, the traditional scheme is to measure parameters such as the resin liquid level and the temperature in the material tray, and a contact type sensor and a non-contact type sensor are usually used for measuring.

In actual use, there is a situation where the resin needs to be replaced. When using a contact sensor, it requires to come into contact with the resin. If the type of resin is different, the resin that sticks to the contact sensor can easily contaminate a resin to be replaced. For example, if there are differences between a previously used resin and a subsequently used resin in terms of color, safety level requirements, and respective characteristics, when the resin is replaced, the respective characteristics, color and safety level of the subsequently used resin may be affected by the previously used resin. At present, there is an urgent need for a solution capable of measuring a liquid level and avoiding resin contamination.

### SUMMARY

The objective of the present disclosure is to provide a liquid level measurement device, method and apparatus, a storage medium and a 3D printer, so as to solve the technical problems of high costs and low measurement accuracy in the prior art.

To achieve the above objective, the embodiments of the present disclosure adopt the following technical solutions.

According to a first aspect, an embodiment of the present disclosure provides a liquid level measurement device, including:
a first excitation circuit, configured to output a first voltage signal according to an input first excitation signal and a current liquid level;
a first detection circuit, configured to extract a signal feature of the first voltage signal, wherein the signal feature includes a peak value, a peak-to-peak value and/or a minimum value; and
a comparison and amplification circuit, configured to output a second voltage signal according to the signal feature and a first preset reference voltage, wherein the second voltage signal is configured to represent a height corresponding to the current liquid level.

The excitation circuit of the device obtains the signal feature of the first voltage signal by means of detection according to the first excitation signal and the first voltage signal generated at the current liquid level, compares same with the first preset reference voltage, and amplifies same to obtain the second voltage signal representing the height of the current liquid level, thereby determining the liquid level, this can eliminate the need for hydraulic measurement devices, floating ball type measurement devices, ultrasonic measurement devices, etc., it can result in a small occupied volume and low cost. The comparison and amplification circuit can perform differential amplification on the signals, thereby improving amplification factor and measurement precision.

In one of the embodiments, the first excitation circuit includes a detection capacitor and a divider resistor; the detection capacitor is formed by a probe extending into a container;
a first end of the detection capacitor is grounded; a second end of the detection capacitor is electrically connected to an input end of the first detection circuit, and is electrically connected to a first end of the divider resistor; a second end of the divider resistor is configured to receive the first excitation signal; or,
the first end of the voltage divider resistor is electrically connected to the first detection circuit and is electrically connected to the second end of the detection capacitor; the second end of the voltage divider resistor is grounded; and the first end of the detection capacitor is configured to receive the first excitation signal.

In one of the embodiments, the first excitation circuit further includes an excitation voltage follower;
an output end of the excitation voltage follower is electrically connected to the input end of the first detection circuit; and an input end of the excitation voltage follower is connected to a connection point of the detection capacitor and the divider resistor.

In one of the embodiments, the first detection circuit includes a detection diode, a peak detection capacitor and a first resistor; and an anode of the detection diode is electrically connected to an output end of the first excitation circuit; a first end of the peak detection capacitor is electrically connected to a cathode of the detection diode, a first end of the first resistor, and an input end of the comparison and amplification circuit; a second end of the peak detection capacitor and a second end of the first resistor are both grounded.

In one of the embodiments, the first detection circuit further includes a detection voltage follower, and the first end of the peak value detection capacitor is electrically connected to the input end of the comparison and amplification circuit by means of the detection voltage follower.

In one of the embodiments, the first detection circuit includes a comparator; the comparator includes a first input end electrically connected to the first excitation circuit and a second input end is configured to input a preset detection reference voltage;
the comparator is configured to output a square wave with a varying duty cycle according to a comparison of the first voltage signal output by the first excitation circuit and the preset detection reference voltage, wherein the duty cycle is proportional to a peak value of the first voltage signal;
the first detection circuit further includes an active filter circuit or a mean value detection circuit; an output end of the comparator is connected to an input end of the active filter circuit or an input end of the mean value detection circuit; and an output end of the active filter circuit or an output end of the mean value detection circuit is electrically connected to the comparison and amplification circuit;
the active filter circuit or the mean value detection circuit is configured to obtain a mean value of the square wave, wherein the mean value is proportional to the duty cycle of the square wave.

In one of the embodiments, the liquid level measurement device further includes a first reference voltage circuit configured to provide the first preset reference voltage.

In one of the embodiments, the first reference voltage circuit includes a reference voltage follower and a low-pass filter circuit; the low-pass filter circuit includes an output end connected to an input end of the reference voltage follower; and an input end connected to a processing circuit; an output end of the reference voltage follower is electrically connected to the comparison and amplification circuit.

In one of the embodiments, there are a plurality of low-pass filter circuits; an output end of the plurality of low-pass filter circuits after being connected in series is connected to the input end of the reference voltage follower; and an input end of the plurality of low-pass filter circuits after being connected in series is configured to be connected to the processing circuit.

In one of the embodiments, the low-pass filter circuit includes a filter resistor and a filter capacitor; a first end of the filter resistor is the input end of the low-pass filter circuit; a second end of the filter resistor is electrically connected to a first end of the filter capacitor; the first end of the filter capacitor is the output end of the low-pass filter circuit; and a second end of the filter capacitor is grounded.

In one of the embodiments, the first reference voltage circuit includes a DAC circuit; and the input end of the comparison and amplification circuit is connected to the DAC circuit.

In one of the embodiments, the comparison and amplification circuit includes a fourth resistor, a fifth resistor, a sixth resistor, a seventh resistor and an operational amplifier;
a non-inverting input end of the operational amplifier is connected to a first end of the fourth resistor and a first end of the sixth resistor; an inverting input end of the operational amplifier is connected to a first end of the fifth resistor and a first end of the seventh resistor; an output end of the operational amplifier is connected to a second end of the seventh resistor, and is configured to be connected to an MCU; a second end of the fourth resistor is connected to the first preset reference voltage; and a second end of the fifth resistor is connected to the output end of the first detection circuit; a second end of the sixth resistor is grounded.

In one of the embodiments, the liquid level measurement device further includes:
a second excitation circuit, configured to output a third voltage signal according to an input second excitation signal and the current liquid level, wherein an input end of the second excitation circuit is connected to an input end of the first excitation circuit;
a second detection circuit, configured to extract a signal feature of the third voltage signal;
a second reference voltage circuit;
a subtraction circuit, wherein a first input end of the subtraction circuit is connected to an output end of the first detection circuit and an output end of the second detection circuit; a second input end of the subtraction circuit is connected to the second reference voltage circuit; and an output end of the subtraction circuit is connected to the input end of the comparison and amplification circuit; the subtraction circuit is configured to obtain a signal feature of a fourth voltage signal according to the signal feature of the first voltage signal, the signal feature of the third voltage signal and a second preset reference voltage provided by the second reference voltage circuit;
the comparison and amplification circuit is configured to output a fifth voltage signal according to the signal feature of the first voltage signal, the signal feature of the fourth voltage signal and the first preset reference voltage.

In one of the embodiments, the first excitation circuit includes a first detection capacitor and a first divider resistor; the first detection capacitor is formed by a first probe and a second probe which extend into a container; the second probe is configured to contact a liquid at a first liquid level; a first end of the first detection capacitor is grounded; a second end of the first detection capacitor is electrically connected to the first detection circuit and is electrically connected to a first end of the first divider resistor; and a second end of the first divider resistor is configured to receive the first excitation signal; or the first end of the first divider resistor is electrically connected to the first detection circuit and is electrically connected to a second end of the first detection capacitor; the second end of the first divider resistor is grounded; the first end of the first detection capacitor is configured to receive the first excitation signal;
the second excitation circuit includes a second detection capacitor and a second divider resistor; the second detection capacitor is formed by the first probe and a third probe; the third probe is configured to contact the liquid at a second liquid level; a resistance value of the second divider resistor is greater than a resistance value of the first divider resistor; the first liquid level is lower than the second liquid level;
a first end of the second detection capacitor is grounded; a second end of the second detection capacitor is electrically connected to the first detection circuit and is electrically connected to a first end of the second divider resistor; and a second end of the second divider resistor is configured to receive the second excitation signal; or, a first end of the second divider resistor is electrically connected to the first detection circuit and is electrically connected to the second end of the second detection capacitor; the second end of the second divider resistor is grounded; and the first end of the second detection capacitor is configured to be connected to the second excitation signal.

In one of the embodiments, the second reference voltage circuit includes a buck diode and a grounding resistor; a cathode of the buck diode is grounded by means of the grounding resistor; and an anode of the buck diode is configured to be connected to a reference power supply, and is configured to reduce a voltage of the reference power supply and output the second preset reference voltage.

According to a second aspect, an embodiment of the present disclosure further provides a liquid level measurement method, which is applied to the foregoing liquid level measurement device, the liquid level measurement method includes:
acquiring a second voltage signal;
determining that zeroing is successful in cases where a voltage value associated with the second voltage signal falls within a preset range;
reading a current second voltage signal and/or a current temperature signal according to a received liquid reading instruction; and
obtaining a current liquid level according to the current second voltage signal and/or the current temperature signal.

According to a third aspect, the embodiments of the present disclosure further provide a liquid level measurement apparatus, which is applied to the liquid level measurement device. The liquid level measurement apparatus includes:
a zeroing unit, configured to acquire a second voltage signal, and in cases where a voltage value associated with the second voltage signal falls within a preset range, determine that zeroing is successful;
a calculation unit, configured to, in cases where zeroing is successful, read a current second voltage signal and/or a current temperature signal according to a received liquid reading instruction, obtain a current liquid level according to the current second voltage signal, or obtain the current liquid level according to the current second voltage signal and the current temperature signal.

According to a fourth aspect, an embodiment of the present disclosure further provides a computer readable storage medium, storing a computer program or an instruction which, when executed by a computing device, implements the liquid level measurement method.

According to a fifth aspect, an embodiment of the present disclosure further provides a liquid level measurement device, the liquid level measurement device includes:
a material tray frame;
a detection assembly provided on the material tray frame, wherein a sensitive element of the detection assembly extends into a liquid storage area of the material tray frame; and
a processing assembly provided on a 3D printer body, wherein the processing assembly is detachably connected to the detection assembly.

As at least one alternative embodiment, the liquid level measurement device further includes a connection structure; the connection structure includes a first connection structure and a second connection structure detachably connected to the first connection structure; the detection assembly is connected to the first connection structure; the processing assembly is connected to the second connection structure.

As at least one alternative embodiment, the detection assembly includes a first detection chip and a plurality of sensitive elements;
the first detection chip is provided in the material tray frame or on the 3D printer body, and is connected to the first connection structure;
each of the sensitive elements is detachably connected or fixedly connected to the first detection chip, and each of the sensitive elements extends into the liquid storage area of the material tray frame.

As at least one alternative embodiment, the first detection chip includes a first excitation circuit, a first detection circuit and a comparison and amplification circuit;
the first excitation circuit is configured to output a first voltage signal according to an input first excitation signal and a current liquid level;
the first detection circuit is configured to extract a signal feature of the first voltage signal; wherein the signal feature includes a peak value, a peak-to-peak value and/or a minimum value; and
the comparison and amplification circuit is configured to output a second voltage signal according to the signal feature and a first preset reference voltage, wherein the second voltage signal is configured to represent a height corresponding to the current liquid level.

As at least one alternative embodiment, the first excitation circuit includes a divider resistor; the sensitive element is a probe extending into a container, and a detection capacitor is formed by the probe extending into the container;
a first end of the detection capacitor is grounded; a second end of the detection capacitor is electrically connected to an input end of the first detection circuit, and is electrically connected to a first end of the divider resistor; a second end of the divider resistor is configured to receive the first excitation signal; or,
the first end of the divider resistor is electrically connected to the first detection circuit and is electrically connected to the second end of the detection capacitor; the second end of the divider resistor is grounded; and the first end of the detection capacitor is configured to receive the first excitation signal.

As at least one alternative embodiment, the first excitation circuit further includes an excitation voltage follower;
an output end of the excitation voltage follower is electrically connected to the input end of the first detection circuit; and an input end of the excitation voltage follower is connected to a connection point of the detection capacitor and the divider resistor.

As at least one alternative embodiment, the first detection circuit includes a detection diode, a peak detection capacitor and a first resistor; and an anode of the detection diode is electrically connected to an output end of the first excitation circuit; a first end of the peak detection capacitor is electrically connected to a cathode of the detection diode, a first end of the first resistor, and an input end of the comparison and amplification circuit; a second end of the peak detection capacitor and a second end of the first resistor are both grounded.

As at least one alternative embodiment, the first detection circuit further includes a detection voltage follower, and the first end of the peak value detection capacitor is electrically connected to the input end of the comparison and amplification circuit by means of the detection voltage follower.

As at least one alternative embodiment, the first detection circuit includes a comparator; the comparator includes a first input end electrically connected to the first excitation circuit and a second input end configured to input a preset detection reference voltage;
the comparator is configured to output a square wave with a varying duty cycle according to a comparison of the first voltage signal output by the first excitation circuit and the preset detection reference voltage, wherein the duty cycle is proportional to a peak value of the first voltage signal;
the first detection circuit further includes an active filter circuit or a mean value detection circuit; an output end of the comparator is connected to an input end of the active filter circuit or an input end of the mean value detection circuit; and an output end of the active filter circuit or an output end of the mean value detection circuit is electrically connected to the comparison and amplification circuit;
the active filter circuit or the mean value detection circuit is configured to obtain a mean value of the square wave, wherein the mean value is proportional to the duty cycle of the square wave.

As at least one alternative embodiment, the liquid level measurement device further includes a first reference voltage circuit configured to provide the first preset reference voltage.

In an optional embodiment, the first reference voltage circuit includes a reference voltage follower and a low-pass filter circuit; the low-pass filter circuit includes a first input end connected to an input end of the reference voltage follower and an input end connected to a processing circuit; an output end of the reference voltage follower is electrically connected to the comparison and amplification circuit.

As at least one alternative embodiment, there are a plurality of low-pass filter circuits; an output end of the plurality of low-pass filter circuits after being connected in series is connected to the input end of the reference voltage follower; and an input end of the plurality of low-pass filter circuits after being connected in series is configured to be connected to the processing circuit.

As at least one alternative embodiment, the low-pass filter circuit includes a filter resistor and a filter capacitor; a first end of the filter resistor is the input end of the low-pass filter circuit; a second end of the filter resistor is electrically connected to a first end of the filter capacitor; the first end of the filter capacitor is the output end of the low-pass filter circuit; and a second end of the filter capacitor is grounded.

As at least one alternative embodiment, the first reference voltage circuit includes a DAC circuit; and an input end of the comparison and amplification circuit is connected to the DAC circuit.

As at least one alternative embodiment, the comparison and amplification circuit includes a fourth resistor, a fifth resistor, a sixth resistor, a seventh resistor and an operational amplifier;
a non-inverting input end of the operational amplifier is connected to a first end of the fourth resistor and a first end of the sixth resistor; an inverting input end of the operational amplifier is connected to a first end of the fifth resistor and a first end of the seventh resistor; an output end of the operational amplifier is connected to a second end of the seventh resistor, and is configured to be connected to an MCU; a second end of the fourth resistor is connected to the first preset reference voltage; and a second end of the fifth resistor is connected to an output end of the first detection circuit; a second end of the sixth resistor is grounded.

As at least one alternative embodiment, the liquid level measurement device further includes:
a second excitation circuit, configured to output a third voltage signal according to an input second excitation signal and the current liquid level, wherein an input end of the second excitation circuit is connected to an input end of the first excitation circuit;
a second detection circuit, configured to extract a signal feature of the third voltage signal;
a second reference voltage circuit;
a subtraction circuit, wherein a first input end of the subtraction circuit is connected to an output end of the first detection circuit and an output end of the second detection circuit; a second input end of the subtraction circuit is connected to the second reference voltage circuit; and an output end of the subtraction circuit is connected to the input end of the comparison and amplification circuit; the subtraction circuit is configured to obtain a signal feature of a fourth voltage signal according to the signal feature of the first voltage signal, the signal feature of the third voltage signal and a second preset reference voltage provided by the second reference voltage circuit;
the comparison and amplification circuit is configured to output a fifth voltage signal according to the signal feature of the first voltage signal, the signal feature of the fourth voltage signal and the first preset reference voltage.

As at least one alternative embodiment, the first excitation circuit includes a divider resistor; the sensitive element includes a first probe and a second probe which extend into the container, and a first detection capacitor is formed by the first probe and the second probe; the second probe is configured to contact a liquid at a first level;
a first end of the first detection capacitor is grounded; a second end of the first detection capacitor is electrically connected to the first detection circuit and is electrically connected to a first end of the first divider resistor; and a second end of the first divider resistor is configured to receive the first excitation signal; or the first end of the first divider resistor is electrically connected to the first detection circuit and is electrically connected to a second end of the first detection capacitor; the second end of the first divider resistor is grounded; the first end of the first detection capacitor is configured to receive the first excitation signal;
the second excitation circuit includes a second divider resistor; the sensitive element includes the first probe and the third probe which extend into the container, and a second detection capacitor is by to the first probe and a third probe; the third probe is configured to contact the liquid at a second liquid level; a resistance value of the second divider resistor is greater than a resistance value of the first divider resistor; the first level liquid is lower than the second liquid level;
a first end of the second detection capacitor is grounded; a second end of the second detection capacitor is electrically connected to the first detection circuit and is electrically connected to a first end of the second divider resistor; and a second end of the second divider resistor is configured to receive the second excitation signal; or, a first end of the second divider resistor is electrically connected to the first detection circuit and is electrically connected to a second end of the second detection capacitor; the second end of the second divider resistor is grounded; and the first end of the second detection capacitor is configured to receive the second excitation signal.

As at least one alternative embodiment, the second reference voltage circuit includes a buck diode and a grounding resistor; a cathode of the buck diode is grounded by means of the grounding resistor; and an anode of the buck diode is configured to be connected to a reference power supply, and is configured to reduce a voltage of the reference power supply and output the second preset reference voltage.

As at least one alternative embodiment, the processing assembly includes a second detection chip and a controller;
the second detection chip and the controller are both provided on the 3D printer body; one end of the second detection chip is connected to the controller; and the other end thereof is connected to the second connection structure.

As at least one alternative embodiment, the material tray frame includes a material tray outer frame and a material tray inner frame; the material tray outer frame and the material tray inner frame are connected by a material tray bottom wall; an accommodating cavity is formed between the material tray outer frame and the material tray inner frame; and the first detection chip and the probes are all provided in the accommodating cavity.

As at least one alternative embodiment, a fixing assembly is further provided in the accommodating cavity, and the fixing assembly includes a first bearing member and a second bearing member;
each of the sensitive elements is placed on the first bearing member and the second bearing member; and one end of each of the sensitive elements extends into the liquid storage area of the material tray inner frame.

As at least one alternative embodiment, the first bearing member includes a partition plate and placement members, wherein the partition plate is provided in the accommodating cavity and separates the accommodating cavity, and the placement members are respectively provided at two sides of the partition plate;
the second bearing member is provided with a plurality of grooves; the positions of the grooves correspond to the positions of the sensitive elements on a one-to-one basis; and each of the sensitive elements is placed in the placement member and grooves at the corresponding positions and then extends into the liquid storage area of the material tray inner frame.

As at least one alternative embodiment, the device further includes a female header socket, wherein each of the sensitive elements is connected to the first detection chip by means of the female header socket;
the first bearing member is a bearing plate, a plurality of grooves are provided on the bearing plate, and the number of the grooves corresponds to the number of the sensitive elements;
the second bearing member is provided with a plurality of channels and a plurality of through holes; and the number of channels and the number of through holes correspond to the number of the sensitive elements;
each of the sensitive elements is provided in the corresponding groove of the first bearing member and the corresponding channel of the second bearing member, and extends into the liquid storage area of the material tray inner frame by means of the corresponding through hole.

As at least one alternative embodiment, a material tray cover is provided on an end face between the material tray outer frame and the material tray inner frame, and a plurality of limiting members are provided on the material tray cover;
each of the limiting members is configured to cooperate with the first bearing member and the second bearing member, so as to limit the position of each of the sensitive elements.

According to a sixth aspect, an embodiment of the present disclosure provides a 3D printer, including a resin bottle assembly, a 3D printer body, and the liquid level measurement device according to any one of the foregoing embodiments;
the resin bottle assembly is snapped-fitted onto an outer wall of a material tray frame of the liquid level measurement device;
a sliding groove is provided on an inner side wall of the 3D printer body, and the material tray frame of the liquid level measurement device is slidably provided at the sliding groove.

### BRIEF DESCRIPTION OF THE DRAWINGS

In order to more clearly illustrate the technical solutions of the present disclosure, drawings which need to be used therein will be introduced below briefly. It should be understood that the drawings below merely show some embodiments of the present disclosure, and therefore should not be considered as limitation to the scope. Those ordinarily skilled in the art still could obtain other relevant drawings according to these drawings, without using any creative efforts.

FIG. 1 is a first schematic diagram of a liquid level measurement device according to an embodiment of the present disclosure;

FIG. 2 is a second schematic diagram of a liquid level measurement device according to an embodiment of the present disclosure;

FIG. 3 is a schematic diagram of a first detection circuit according to an embodiment of the present disclosure;

FIG. 4 is a schematic diagram of a liquid level measurement device with high limit detection according to an embodiment of the present disclosure;

FIG. 5 is an overall schematic structural diagram of a liquid level measurement device of a 3D printer according to an embodiment of the present disclosure;

FIG. 6 is an overall schematic structural diagram of a liquid level measurement device according to an embodiment of the present disclosure;

FIG. 7 is an overall schematic structural diagram of a liquid level measurement device in cases where there are two sensitive elements according to an embodiment of the present disclosure;

FIG. 8 is a partial enlarged view of a detection assembly in a liquid level measurement device in cases where there are two sensitive elements according to an embodiment of the present disclosure;

FIG. 9 is a schematic structural diagram of a detection assembly in a liquid level measurement device in cases where there are a plurality of sensitive elements according to an embodiment of the present disclosure;

FIG. 10 is a partial enlarged view of a detection assembly in a liquid level measurement device in cases where there are a plurality of sensitive elements according to an embodiment of the present disclosure;

FIG. 11 is a schematic structural diagram of a limiting member in a liquid level measurement device in cases where there are two sensitive elements according to an embodiment of the present disclosure;

FIG. 12 is a first schematic structural diagram of a limiting member in a liquid level measurement device in cases where there are a plurality of sensitive elements according to an embodiment of the present disclosure;

FIG. 13 is a second schematic structural diagram of a limiting member in a liquid level measurement device in cases where there are a plurality of sensitive elements according to an embodiment of the present disclosure;

### DESCRIPTION OF REFERENCE SIGNS

11: first excitation circuit, 12: first detection circuit, 121: active filter circuit or mean value detection circuit, 13: comparison and amplification circuit, 14: first reference voltage circuit, 15: second excitation circuit, 16: second detection circuit, 17: second reference voltage circuit, 18: subtraction circuit; 100: liquid level measurement device; 101: material tray frame; 1011: material tray outer frame 1012: material tray inner frame; 102: detection assembly; 1021: first detection chip; 1022: sensitive element; 1023: rubber core; 1024: female header socket; 103: processing assembly; 104: first bearing member; 1041: partition plate; 1042: placement plate; 105: second bearing member; 106: limiting member; 107: material tray cover; 200: resin bottle assembly; 201: 3D printer body; 300: 3D printer.

### DETAILED DESCRIPTION OF THE EMBODIMENTS

To make the objects, technical solutions, and advantages of the embodiments of the present disclosure clearer, hereinafter, the technical solutions in the embodiments of the present disclosure will be described clearly and thoroughly with reference to the accompanying drawings of the embodiments of the present disclosure. Obviously, the embodiments as described are some of the embodiments of the present disclosure, and are not all of the embodiments of the present disclosure. Generally, components in the embodiments of the present disclosure, as described in the drawings herein, may be arranged and designed in a variety of different configurations. The following embodiments and features in the embodiments may be combined with one another without conflicts.

In the description of the present disclosure, it should be noted that, relational terms such as first and second are only used to distinguish one entity or operation from another entity or operation, and do not require or imply any actual relationship or sequence between these entities or operations. The term “connection” should be understood in a broad sense, for example, the connection may be a fixed connection, or a detachable connection, or an integral connection; may be a direct connection, and also may be an indirect connection through a medium.

In 3D printing based on UV curing, the liquid level of the liquid photosensitive resin material needs to be measured. As a non-conductive liquid material, photosensitive resin renders conventional measurement methods based on changes in connectivity due to liquid conductivity inapplicable.

However, hydraulic measurement devices, floating ball type measurement devices, ultrasonic measurement devices, etc. are unsuitable for cost-sensitive 3D printing equipment due to occupying the large volume, having the low measurement precision, or having the high construction costs. The laser type measurement devices have the advantage of being non-contact, but they cannot measure the liquid level of transparent resin, lacking versatility.

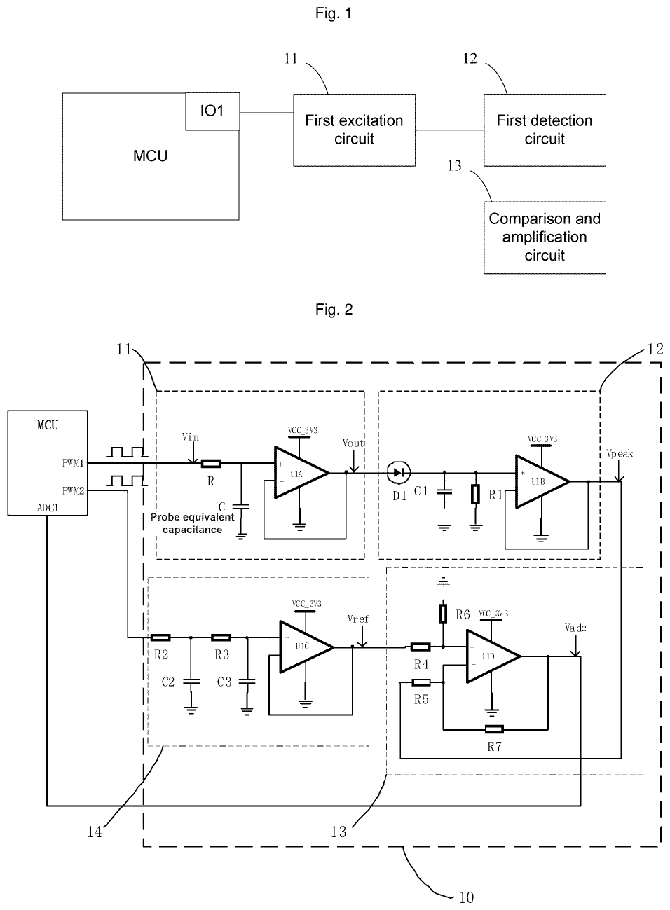

In order to overcome the above problems, reference can be made to FIG. 1. The embodiments of the present disclosure provide a liquid level measurement device 100, including: a first excitation circuit 11 configured to output a first voltage signal according to an input first excitation signal and a current liquid level; a first detection circuit 12, configured to extract a signal feature of the first voltage signal, wherein the signal feature includes a peak value, a peak-to-peak value and/or a minimum value; and a comparison and amplification circuit 13, configured to output a second voltage signal according to the signal feature of the first voltage signal and a first preset reference voltage, wherein the second voltage signal is configured to represent a height corresponding to the current liquid level.

The first excitation signal may be a PWM signal, and the signal acts on the first excitation circuit. The first excitation circuit includes an equivalent capacitor composed of a probe. The current liquid level and the frequency of the first excitation signal determine a capacitive reactance of the equivalent capacitor, and further affect the signal feature of the first voltage signal.

It should be noted that, the comparison and amplification circuit differentially amplifies the signal feature of the first voltage signal and the first preset reference voltage, so as to increase the amplification factor of the resin liquid level. In the first embodiment, the second voltage signal is in a mapping relationship with the current liquid level; therefore, when the second voltage signal is obtained, the height value of the liquid level can be obtained according to the mapping relationship.

In the embodiments of the present disclosure, a second voltage signal representing the current liquid level height may be obtained by means of the first excitation circuit, the first detection circuit and the comparison and amplification circuit, thereby determining the liquid level, this eliminates the need for the hydraulic measurement devices, the floating ball type measurement devices, the ultrasonic measurement devices, etc., resulting in a small occupied volume. The comparison and amplification circuit can improve the amplification factor and measurement precision. In conclusion, the probe-type resin liquid level measurement device based on capacitance variation provided in the present disclosure has the advantages of small device volume, high measurement precision, low construction cost and high practicability.

In one embodiment, a contact sensor is used to measure a liquid level; the probe of the contact sensor may be arranged on the material tray of the 3D printer; and the probe is connected to the subsequent first excitation circuit, the first detection circuit and the comparison and amplification circuit by means of contact points and contact terminals. The probe of the sensor is discarded together with the material tray when the material tray needs to be discarded. In another embodiment, the first excitation circuit and the first detection circuit can be arranged on a material tray; devices such as the first reference voltage circuit, the comparison and amplification circuit and a controller may be arranged on a printer body; the first detection circuit and the comparison and amplification circuit may be electrically connected by contact terminals and contact points; when the material tray needs to be discarded, the probe and a circuit board provided with the first excitation circuit and the first detection circuit can be discarded together with the material tray, thereby avoiding the problem of resin contamination during replacement of the resin of the material tray.

The first excitation signal input by the first excitation circuit may be a PWM1 waveform having an excitation frequency of f and emitted by an output end IO1 of the MCU; and a detection probe in the excitation circuit is inserted into a resin tray and fixed; although the resin is not electrically conductive, a change of the resin liquid level will affect a medium between the two detection probes (changing from air to resin, i.e. a dielectric constant is changed), thereby changing the equivalent capacitance of the probes. This change in capacitance is converted into a change in a DC voltage amount by means of the first excitation circuit and the first detection circuit. The final output signal is an analog voltage value which is an amplified value according to the change of capacitance due to the resin liquid level change and thus capable of being sampled by an ADC. The MCU may calculate the current resin liquid level on the basis of the sampled digital value.

It should be noted that the dielectric constant of each resin material is different, and they are differently affected by their own temperatures. If a more accurate liquid level reading is required, separate experiments can be performed on each resin material to obtain a ratio coefficient between the ADC value and the liquid level; and a temperature sensor is added to measure the resin temperature. When the MCU calculates the current liquid level, the resin temperature value can be used as an auxiliary parameter for performing corresponding compensation.

In one of the embodiments, the first excitation circuit includes a detection capacitor and a divider resistor. The detection capacitor and the divider resistor are connected in series for voltage division, and the voltage of one of the detection capacitor or the divider resistor may be associated with liquid level information. The voltage may be the voltage of the detection capacitor or may be the voltage of the divider resistor. That is, there are two cases as follows:
1) a first end of the detection capacitor is grounded; a second end of the detection capacitor is electrically connected to an input end of the first detection circuit 12, and is electrically connected to a first end of the divider resistor; a second end of the divider resistor is configured to receive the first excitation signal; and
(2) the first end of the divider resistor is electrically connected to the first detection circuit 12 and is electrically connected to the second end of the detection capacitor; the second end of the divider resistor is grounded; and the first end of the detection capacitor is configured to receive the first excitation signal.

As shown in FIG. 2, FIG. 2 shows a manner of taking a voltage of the detection capacitor. A probe equivalent capacitor C is the detection capacitor. The first excitation circuit 11 further includes an excitation voltage follower U1A. The excitation voltage follower U1A is configured to avoid the influence of the first detection circuit 12 on the voltage of the detection capacitor. An output end of the excitation voltage follower U1A is electrically connected to the input end of the first detection circuit 12; and an input end of the excitation voltage follower U1A is connected to a connection point of the detection capacitor and the divider resistor.

For the first detection circuit 12, a diode and a capacitor may be provided for detection. As shown in FIG. 2, the first detection circuit 12 includes a detection diode D1, a peak detection capacitor C1, and a first resistor R1. The detection diode D1 can prevent a charge backflow of the capacitor C1; an anode of the detection diode D1 is an input end of the first detection circuit 12; a first end of the peak detection capacitor C1 is electrically connected to a cathode of the detection diode D1, a first end of the first resistor R1 and an input end of the comparison and amplification circuit 13; and a second end of the peak detection capacitor C1 and a second end of the first resistor R1 are both grounded.

After the quasi-sinusoidal wave output by the first excitation circuit passes through the detection diode D1, during the voltage rise of each cycle, the maximum voltage charges the peak detection capacitor C1; and during the voltage falling edge of each cycle, due to the unidirectional conductivity of the detection diode D1, the peak detection capacitor C1 is not able to discharge to the previous stage, and essentially maintains the voltage. The function of the first resistor R1 is: when the peak value of the peak detection capacitor C1 is reduced (due to the change of the liquid level), the peak detection capacitor C1 may discharge the ground by means of the first resistor R1 to reduce the voltage, so that the voltage of the peak detection capacitor C1 can follow the peak value of the quasi-sinusoidal wave in real time. In one embodiment, a time constant related to the first resistor R1 and the peak detection capacitor C1 is of ms level, otherwise, if the value of the first resistor R1 is too small, the capacitor has completely discharged by means of the resistor at the voltage falling edge of the quasi-sinusoidal wave, thereby failing to follow the peak; if the value of the first resistor R1 is too large, when the change of the liquid level causes the peak value to decrease, the decrease of the capacitance voltage is too slow, and the measurement delay is relatively high.

In FIG. 2, the first detection circuit 12 further includes a detection voltage follower U1B, and the first end of the peak value detection capacitor C1 is electrically connected to the input end of the comparison and amplification circuit 13 by means of the detection voltage follower, so that the first detection circuit 12 can be better isolated from a signal of an output side of the first detection circuit.

Different from the structure of the first detection circuit 12 in FIG. 2, in an example, the function of the first detection circuit 12 may also be implemented in the following manner: a comparison result may be output by comparing a signal output by the first excitation circuit 11 with a preset detection reference voltage, wherein since the first excitation circuit 11 outputs a quasi-sinusoidal wave, the comparison result is a square wave, and different duty cycles are presented depending on the output of the first excitation circuit 11, the duty cycle is associated with the liquid level. In addition, the square wave of the duty cycle may be transformed to an mean value of the square wave by means of an active filter circuit or a mean value detection circuit; and the mean value is proportional to the duty cycle of the square wave, i.e., the peak value of the quasi-sinusoidal wave of the signal output by the first excitation circuit 11 may also be obtained. That is, the first detection circuit 12 may include the active filter circuit or the mean value detection circuit.

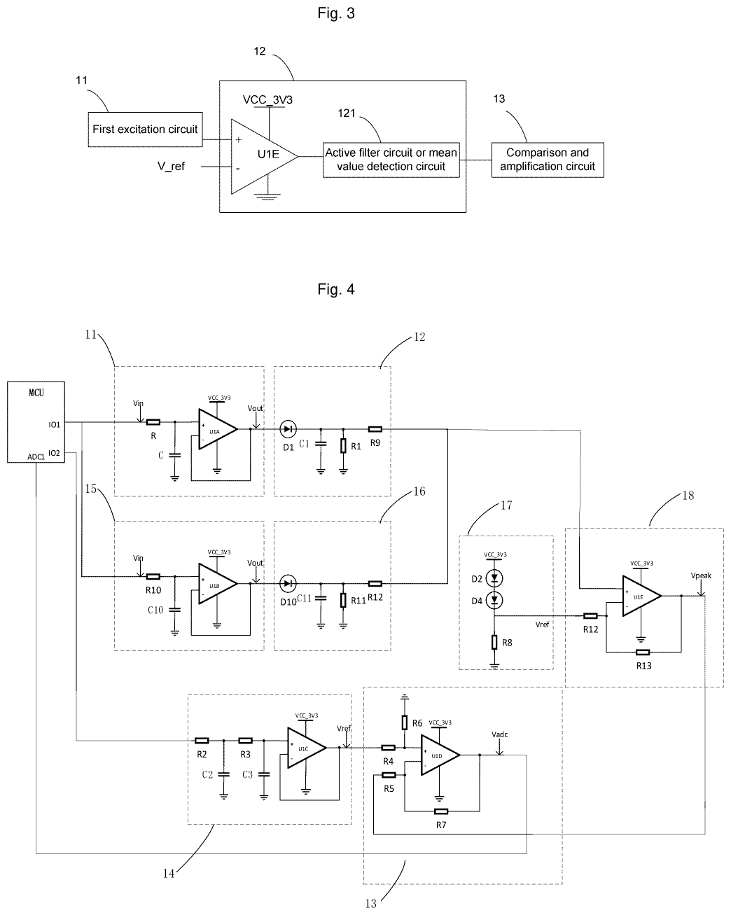

In an embodiment, referring to FIG. 3, the first detection circuit includes a comparator U1E. A first input end of the comparator U1E is the input end of the first detection circuit 12, and a second input end of the comparator is configured to receive a preset detection reference voltage V_ref. The comparator is configured to output a square wave with a varying duty cycle according to the comparison between the first voltage signal of the first excitation circuit 11 and the preset detection reference voltage; and the duty cycle is proportional to the peak value of the first voltage signal, i.e. the peak value of the quasi-sinusoidal wave can also be acquired.

An output end of the comparator is connected to an input end of the active filter circuit or the mean value detection circuit 121; and an output end of the active filter circuit or an output end of the mean value detection circuit 121 is the output end of the first detection circuit 12. The active filter circuit or the mean value detection circuit 121 is configured to obtain a mean value of the square wave, wherein the mean value is proportional to the duty cycle of the square wave. That is, the output voltage is a voltage proportional to the duty cycle of the square wave, which also reflects the height of the liquid level.

With continued reference to FIG. 2, the liquid level measurement device further includes a first reference voltage circuit 14, which may be configured to provide the first preset reference voltage to the comparison and amplification circuit 13. The first reference voltage circuit 14 includes a reference voltage follower U1C and a low-pass filter circuit (including a resistor and a capacitor), wherein the low-pass filter circuit includes an output end connected to an input end of the reference voltage follower U1C and an input end connected to another output end 102 of the MCU. An output end of the reference voltage follower U1C is the output end of the first reference voltage circuit 14. By means of the first reference voltage circuit, a stable and adjustable first preset reference voltage may be obtained. It should be noted that the first reference voltage circuit only needs to output a stable first preset reference voltage, and other types of reference voltage circuits in the prior art should also be included within the scope of protection of the present disclosure.

In FIG. 2, there are two low-pass filter circuits, that is, a second-order RC low-pass filter is used to enhance a steep drop characteristic of a filter in a cut-off region, so that an output voltage ripple of the stage is smaller. The cut-off frequency of the filter is set below kHz.

It should be noted that, the order may also be freely selected, and may be a first order, a second order, a higher order, etc.

As another alternative scheme for obtaining a reference voltage, a reference voltage may be obtained by using a DAC circuit, i.e. the first reference voltage circuit 14 includes the DAC circuit; the input end of the comparison and amplification circuit is connected to the DAC circuit; and the DAC circuit is configured to converting a digital quantity into an analogue quantity, and may adjust an output voltage according to an input digital value.

In an embodiment, the comparison and amplification circuit includes a fourth resistor R4, a fifth resistor R5, a sixth resistor R6, a seventh resistor R7 and an operational amplifier U1D;
a non-inverting input end of the operational amplifier is connected to a first end of the fourth resistor and a first end of the sixth resistor; an inverting input end of the operational amplifier is connected to a first end of the fifth resistor and a first end of the seventh resistor; an output end of the operational amplifier is connected to a second end of the seventh resistor, and is configured to be connected to an MCU; a second end of the fourth resistor may input the first preset reference voltage; and a second end of the fifth resistor is connected to the output end of the first detection circuit; a second end of the sixth resistor is grounded.

For example, two input ends of the operational amplifier are electrically connected to the first end of the fourth resistor and the first end of the fifth resistor; and the second end of the fourth resistor and the second end of the fifth resistor are two input ends of the comparison and amplification circuit;
a non-inverting input end of the operational amplifier is grounded by means of the sixth resistor; the seventh resistor is connected between the output end and the inverting input end of the operational amplifier; and the output end of the operational amplifier is an output end of the comparison and amplification circuit.

Referring to FIG. 4, to avoid detection failure at high liquid levels, a second excitation circuit 15 for measuring the second liquid level is also provided in FIG. 4; and the second excitation circuit 15 is configured to output a third voltage signal according to an input second excitation signal and the current liquid level, wherein an input end of the second excitation circuit is connected to an input end of the first excitation circuit. By the same reasoning, a second detection circuit 16 is provided, and the second detection circuit 16 is configured to extract a signal feature of the third voltage signal, and the circuit structure of the second detection circuit may be the same as that of the first detection circuit. The signal feature includes a peak value, a peak-to-peak value, and a minimum value. A first input end of the subtraction circuit 18 is connected to an output end of the second detection circuit; a second input end of the subtraction circuit 18 is connected to a second reference voltage circuit; and an output end of the subtraction circuit 18 is connected to the input end of the comparison and amplification circuit; the subtraction circuit is configured to obtain a signal feature of a fourth voltage signal according to the signal feature of the third voltage signal and the second reference voltage provided by the second reference voltage circuit 17; the comparison and amplification circuit 13 is configured to output a fifth voltage signal according to a peak voltage of the first voltage signal, a peak voltage of the fourth voltage signal and the first preset reference voltage. The rate of change of the fifth voltage signal with respect to a liquid level when the liquid level is higher than the second liquid level, is greater than the rate of change of the fifth voltage signal with respect to the liquid level when the liquid level is lower than the upper limit.

In particular, the second reference voltage circuit 17 is configured to provide a second preset reference voltage. The subtraction circuit 18 is configured to perform subtraction on the superposed value of the signal feature of the first voltage signal and the signal feature of the third voltage signal, and the second preset reference voltage; and an obtained signal is input to an input end of the comparison and amplification circuit. In a specific embodiment, a required reference voltage can be obtained by stepping down a constant power supply voltage by means of a diode, that is, as shown in FIG. 4, the second reference voltage circuit 17 is arranged to include buck diodes D2 and D4 and a grounding resistor R8; the number of the buck diodes can be set as required. In an example, the number of the buck diodes may be two. The cathodes of the buck diodes D2 and D4 connected in series are grounded by means of a grounding resistor; the anodes of the buck diodes D2 and D4 connected in series are configured to connect to a reference power supply, and are configured to output a preset reference voltage Vref after the voltage of the reference power supply is reduced. By means of the buck diodes D2 and D4, the voltage drop of the diodes in the first detection circuit and the second detection circuit can be cancelled out. The subtraction circuit 18 may be any one of the subtraction circuits in the art. For example, the subtraction circuit may include the operational amplifier U1E, a resistor R12 and a resistor R13; one end of the resistor R12 is respectively connected to one end of the grounding resistor R8 and the cathode of the buck diode D4; the other end of the resistor R12 is respectively connected to the inverting input end of the operational amplifier U1E and one end of the resistor R13; and the other end of the resistor R13 is connected to the output end of the operational amplifier U1E and the comparison and amplification circuit.

The second excitation circuit 15 and the first excitation circuit 11 share one probe, specifically as follows.

The first excitation circuit 11 includes a first detection capacitor C; and the first detection capacitor C is formed by a first probe and a second probe which extend into the container. The second probe is configured to contact a liquid at a first liquid level, wherein the first liquid level is lower than the second liquid level. The second liquid level is the high limit of the material tray.

The second excitation circuit 15 includes a second detection capacitor C10 formed by the first probe and a third probe. The third probe is configured to contact a liquid at a high limit (i.e. the second liquid level). In addition, the resistance value of the second divider resistor R10 is greater than the resistance value of the first divider resistor R. Further, there is an order of magnitude difference between the resistance value of the second divider resistor R10 and the resistance value of the first divider resistor R.

In this way, when the liquid level is low, the change of the liquid level may not cause the capacitance value of the second detection capacitor C10 to change, so that the liquid level can be measured according to the capacitance value of the first detection capacitor C and the change of the liquid level.

When the liquid is added to make the liquid gradually transition to a level higher than the second liquid level, since the third probe contacts the liquid, the capacitance value of the third probe changes obviously, so that the liquid level can be measured according to the change of the capacitance value of the second detection capacitor C10 with the liquid level. In this case, even if the first detection capacitor fails, an excessively high liquid level can still be detected, allowing a warning to be issued, thus further preventing overflow due to excessive liquid addition. It should be noted that the number of probes is not limited in the present disclosure, and there may be three probes or multiple probes.

It should be further noted that, in cases where the inputs of the first excitation circuit and the second excitation circuit are from the same interface, the first excitation signal and the second excitation signal may be transmitted alternately from the same interface. Due to the difference between the resistance values of the first divider resistor and the second divider resistor, the paths of the first excitation circuit and the first detection circuit and the paths of the second excitation circuit and the second detection circuit may act alternately. There is also an order of magnitude difference between the first excitation signal and the second excitation signal. By means of the described circuit, both liquid level measurement and high liquid level warning can be achieved simultaneously without adding additional interfaces.

On the basis of the described embodiments, the embodiments of the present disclosure further provide a liquid level measurement method, which is applied to the described liquid level measurement device. The method includes:
S1: a second voltage signal is acquired;
S2: that zeroing is successful is determined in cases where a voltage value associated with the second voltage signal falls within a preset range;
S3: a current second voltage signal and/or a current temperature signal is read according to a received liquid reading instruction; and
S4: a current liquid level is obtained according to the current second voltage signal and/or the current temperature signal.

By means of the step of zeroing, an initial second voltage signal can be controlled within an appropriate range, thereby facilitating more accurate reflection when a subsequent second voltage signal is changed. Additionally, by adding a temperature signal, compensation for errors caused by the temperature may be performed, thereby preventing temperature variations from affecting the liquid level measurement.

The foregoing method may be applied to the MCU in FIG. 1, FIG. 2 and FIG. 4. The IO1 and the IO2 in FIG. 4 may output a PWM signal. The MCU may be a separate 8-bit or 32-bit microprocessor, and communicate with the upper computer by means of interfaces such as a UART and a I2C; the MCU may also refer to a CPU of a core board of a printer, and the system is constructed by directly using PWM1, PWM2 and ADC resources in the CPU. The overall process is: firstly, initializing I/O attributes; setting the frequencies and initial duty cycles of the PWM1 and the PWM2; completing the ADC and UART configuration; and then, cyclically executing the reception of instructions from the upper computer; exiting a cycle until power is off; and ending. The upper computer may send a zeroing instruction, and may also send a liquid level reading instruction; and the MCU respectively performs a zeroing action or a liquid level reading action at any time according to the zeroing instruction or the liquid level reading instruction.

The zeroing voltage is the second voltage signal obtained from the first preset reference voltage and the peak voltage of the first voltage signal which pass through the comparison and amplification circuit, wherein the preset reference voltage may be formed by the PWM2. When the resin level of the system is zero, the PWM2 waveform having an adjustable duty cycle and emitted by the MCU generates the preset reference voltage to perform zeroing by means of the active filter circuit.

The zeroing mechanism significantly reduces the impact of parasitic parameters of active devices in a system and precision issues of passive devices, such as resistors and capacitors, on measurement errors.

Moreover, the change in capacitance caused by the change in resin level is extremely small, about 0.5 pf. A capacitance range measurable by a multimeter is typically in the μF level. A general oscilloscope has an input capacitance of 10 pf at its probe, which results in a great parasitic parameter. Although general LCR devices can measure the capacitance at the pf level, however, it is extremely expensive, and hence, it is difficult to construct a low-cost detection device, and it needs to consider a simple method and an accurate theoretical calculation. Due to the PWM function commonly available in 8-bit microcontrollers, precise capture of capacitance changes can be achieved. The present disclosure only uses a common 8-bit single chip microcomputer to achieve accurate measurement of the liquid level, and hence, the present disclosure makes a prominent contribution to cost reduction.

In FIG. 2, the PWM1 of the MCU may be configured to output a square wave signal with a 50% of duty cycle as Vin. A resistor R, a probe equivalent capacitor C and a first-stage operational amplifier U1A form a first-order active low-pass filter. After being expanded by the Fourier series, the square wave signal may be considered as a composite signal composed of a direct-current component, a sine wave component with a fundamental frequency being a frequency (also referred to as an excitation frequency) f of the square wave signal, and an odd harmonic wave. However, after active low-pass filtering, the direct-current component completely passes through, and a high harmonic wave is basically attenuated; the fundamental frequency signal is configured such that an input voltage is allocated to a resistor R and a capacitive reactance 1/jωC of a capacitor C according to a complex voltage division rule; finally, a Vout is a similar sinusoidal signal (with a direct-current component) having an amplitude less than Vin and using a fundamental frequency f as a frequency; and a change of the capacitor will affect a voltage division ratio, thereby affecting amplitude of an output voltage.

A waveform obtained by the first excitation circuit is a quasi-sinusoidal wave; an original direct-current component of a PWM1 square wave is superposed; and the value of the direct-current component is generally half of a power supply voltage VCC. The change of the capacitor does not affect the value of the direct-current component, but only affects the peak-to-peak value of the quasi-sinusoidal wave, and therefore, the first detection circuit shown in FIG. 2 is designed to capture the magnitude of the peak in real time.

After the quasi-sinusoidal wave passes through the diode D1, when the voltage of each cycle rises, the maximum value of the voltage of the quasi-sinusoidal wave charges the capacitor C1. At the voltage falling edge of each cycle, due to the unidirectional conductivity of the diode, the capacitor C1 cannot return to the preceding stage for discharge, and basically maintains the voltage. The capacitance value of C1 should be as large as possible to ensure a lower output ripple amplitude. The function of the resistor R1 is to reduce, when the peak value of the capacitor C1 decreases (due to the change of the liquid level), the capacitor C1 may decrease the voltage by discharging the ground by means of R1; in this way, the voltage of C1 follows the peak value of the quasi-sinusoidal wave in real time; the value of R1 cannot be excessively small, otherwise, at the voltage falling edge of the quasi-sinusoidal wave, the capacitor has been completely discharged by means of the resistor, and the effect of following the peak value cannot be achieved; and the value of R1 cannot be too large either, otherwise, when a change in the liquid level causes a decrease in the peak value, the reduction of the voltage of the capacitor is too slow, and the measurement delay is relatively high. Generally, the time constant formed by R1 and C1 is in the order of ms. The second-level operational amplifier U1B, as an emitter follower, can isolate a front-level load and a rear-level load, so that device parameters of the front-level load and the rear-level load do not affect each other.

As stated above, a waveform output from the first detection circuit is a direct-current voltage waveform, which carries a large direct-current component of an original square wave, but a voltage change caused by a changed capacitance is small; if the voltage of the first detection circuit is simply amplified, the amplification factor is even less than 2 times due to a limitation of a power supply voltage. As shown in FIG. 2, in the present disclosure, an operational amplifier is used to establish an adder-subtractor amplification circuit, with R4=R5, R6=R7, Vpeak being an output voltage of peak detection, Vref being an output voltage of the active filter circuit, and a final output voltage Vadc being:

$$Vadc = \frac{R 6}{R 4} ( Vref - Vpeak )$$

As the liquid level increases, the capacitance increases, the capacitive reactance decreases, the Vpeak begins to decrease, and the final Vadc begins to increase, wherein the value of the increase depends on the change in the liquid level and the setting of the amplification factor. Under this circuit design, the amplification factor can reach more than 20 times, which is far higher than the effect of directly amplifying the Vpeak (less than 2 times).

For the PWM2, an initial duty cycle may be set by using an empirical value obtained in an actual debugging process, and then adjustment is performed according to a zeroing sub-process. The zeroing sub-process is as follows:

step 1: the ADC samples a digital value Vdig; the sampling is processed using a digital filtering method which averages multiple consecutive sampling values to reduce errors; the currently measured voltage value is calculated according to the number of bits n of the ADC and the magnitude of the reference voltage Vr

$$Vadc = \frac{Vdig}{{2}^{n}} Vr$$

step 2: if Vadc<0.01 V, it means that the duty cycle of the current PWM2 is too small, Vref is not enough to exceed the output Vpeak of the peak detection circuit, and the duty cycle needs to be increased; after 1 is added to the duty cycle register of the PWM2, return to Step1; if Vadc>0.02V, it means that the duty cycle of the current PWM2 is too large, a part of the direct-current component is coupled to the test result, which affects the determination of the liquid level, and after 1 is subtracted from the duty cycle register of the PWM2, return to Step1; if 0.01V≤Vadc≤0.02V, it is considered that zeroing is successful, and Step 3 is entered.

Step 3: information indicating that zeroing has been completed is sent to the upper computer by means of the UART.

The sub-process of the liquid level reading instruction is:

Step 1: the ADC samples a digital value Vdig; the sampling is processed with digital filtering which uses an Equation 3-3 to obtain Vadc, and then determines, according to a current material type provided by the upper computer, a proportionality coefficient Ktype to be used in this case, and the final height H of the liquid level is:

H=KtypeVadc

Since the temperature will influence the measurement, a temperature sensor may be added to test the resin temperature T, and if the temperature compensation coefficient of the material is Ktem, then the final height H of the liquid level is:

$$H = \{ \begin{matrix}KtypeVadc , & T < 20 °C . \\ KtypeVadc - KtemT , & T \geq 20 °C .\end{matrix}$$

Step 2: information of the liquid level H is sent to the upper computer by means of the UART.

Based on the described liquid level measurement method, the embodiment of the present disclosure further provides a liquid level measurement apparatus for executing the described liquid level measurement method. The apparatus includes:
a zeroing unit, configured to acquire a second voltage signal, and in cases where a voltage value associated with the second voltage signal falls within a preset range, determine that zeroing is successful;
a calculation unit, configured to, in cases where zeroing is successful, read a current second voltage signal and/or a current temperature signal according to a received liquid reading instruction, and obtain a current liquid level according to the current second voltage signal, or obtain a current liquid level according to the current second voltage signal and/or the current temperature signal.

As at least one alternative embodiment, a temperature compensation unit may be provided in the liquid level measurement apparatus, and is configured to generate a temperature signal according to an ambient temperature.

Based on the described liquid level measurement method, the embodiments of the present disclosure further provide a computer readable storage medium, storing a computer program or an instruction which, when executed by a computing device, implements the liquid level measurement method.

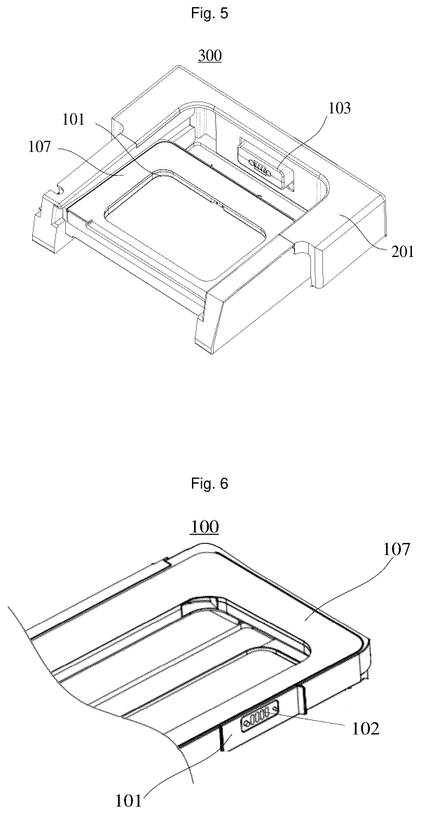

Please refer to FIGS. 5 to 8, the embodiment of the present disclosure provides a liquid level measurement device 100. The liquid level measurement device 100 may be equipped with the resin bottle assembly 200 and applied in a 3D printer 300 to achieve resin liquid level measurement.

In an embodiment of the present disclosure, provided is a liquid level measurement device 100, including:
a material tray frame 101;
a detection assembly 102 is provided on the material tray frame 101, wherein a sensitive element 1022 of the detection assembly 102 extends into a liquid storage area of the material tray frame 101.
a processing assembly (not shown in the figure) is provided in the 3D printer body 201, wherein the processing assembly 103 is detachably connected to the detection assembly 102.

The detection assembly 102 is configured to cooperate with the processing assembly 103 to achieve the measurement of the resin liquid level, and may include a sensitive element, and may also include a sensitive element and a detection circuit. The liquid storage area of the material tray frame 101 is configured to hold a resin. Since the processing assembly 103 is detachably connected to the detection assembly 102, as shown in FIGS. 5 and 6, a contact terminal may be provided on the processing assembly 103; a contact point matching the contact terminal may be provided on the corresponding detection assembly 102; and the two may be in plug-in connection. In a specific example, the liquid level measurement device may further include a connection structure, wherein the connection structure includes a first connection structure and a second connection structure detachably connected to the first connection structure; the detection assembly is connected to the first connection structure; the processing assembly is connected to the second connection structure. The contact point and the contact terminal mentioned above are merely a specific example, and electrical connection may also be implemented in the form of a spring piece, which is not described in detail herein.

As at least one alternative embodiment, the detection assembly 102 may include a corresponding detection circuit (e.g. a first detection chip) and a plurality of detection components (or called as sensitive elements), wherein the sensitive elements are special electronic elements capable of sensing certain physical, chemical and biological information acutely and converting same into electrical information. The detection components may be connected to the detection chip; a contact point in plug-in connection with the processing assembly 103 may be provided on the outer wall of the detection chip; and the detection component may extend into the liquid storage area of the material tray frame body 101, so as to contact the resin contained in the material tray frame 101. In another embodiment, the detection assembly may include the plurality of detection components (or called as the sensitive elements).

As at least one alternative embodiment, the first detection chip may include a first excitation circuit, a first detection circuit and a comparison and amplification circuit; the first excitation circuit is configured to output a first voltage signal according to an input first excitation signal and a current liquid level; the first detection circuit is configured to extract a signal feature of the first voltage signal, wherein the signal feature includes a peak value, a peak-to-peak value and/or a minimum value; and the comparison and amplification circuit is configured to output a second voltage signal according to the signal feature and a first preset reference voltage, wherein the second voltage signal is configured to representing a height corresponding to the current liquid level.

As at least one alternative embodiment, the first excitation circuit may include a divider resistor; the sensitive element may be a probe extending into the container, and a detection capacitor is formed by the probe extending into the container; a first end of the detection capacitor is grounded; a second end of the detection capacitor is electrically connected to the input end of the first detection circuit, and is electrically connected to a first end of the divider resistor; a second end of the divider resistor is configured to receive the first excitation signal; or, the first end of the divider resistor is electrically connected to the first detection circuit and is electrically connected to the second end of the detection capacitor; the second end of the divider resistor is grounded; and the first end of the detection capacitor is configured to receive the first excitation signal.

In the embodiment of the present disclosure, when the height of the resin liquid level in the material tray frame 101 changes, the change of the resin liquid level will affect the medium between the detection components in the detection assembly 102. For example, the sensitive elements 1022 may be multiple probes extending into the container; although the resin is non-conductive, a change in the resin liquid level affects the medium between the probes (i.e., from air to resin, changing the dielectric constant), thereby changing the equivalent capacitance of the probes. This capacitance change is converted into a variation in the direct-current voltage by means of the detection chip in the detection component 102, for example, converting into a change in direct-current voltage by means of the first excitation circuit and the first detection circuit. The final output signal is an analog voltage value which is amplified due to the change in capacitance caused by the resin level change, and may be sampled by the ADC. The MCU may then calculate the current resin level on the basis of the sampled digital value.

As at least one alternative embodiment, a contact sensor is used to measure a liquid level; the probe of the contact sensor may be arranged on the material tray of the 3D printer; and the probe is connected to the subsequent first excitation circuit, the first detection circuit and the comparison and amplification circuit by means of contact points and contact terminals. The probe of the sensor is discarded together when the material tray needs to be discarded. In another embodiment, the first excitation circuit and the first detection circuit can be arranged on a material tray; devices such as the first reference voltage circuit, the comparison and amplification circuit and the controller may be arranged on a printer body; the first detection circuit and the comparison and amplification circuit may be electrically connected in the form of contact terminals and contact points; when the material tray needs to be discarded, the probe and a circuit board provided with the first excitation circuit and the first detection circuit can be discarded together with the material tray, thereby avoiding the problem of resin contamination during replacement of the resin of the material tray.

As at least one alternative embodiment, the first excitation circuit further includes an excitation voltage follower; an output end of the excitation voltage follower is electrically connected to the input end of the first detection circuit; and an input end of the excitation voltage follower is connected to a connection point of the detection capacitor and the divider resistor.

As at least one alternative embodiment, the first detection circuit includes a detection diode, a peak detection capacitor and a first resistor; and an anode of the detection diode is electrically connected to an output end of the first excitation circuit; a first end of the peak detection capacitor is electrically connected to a cathode of the detection diode, a first end of the first resistor, and an input end of the comparison and amplification circuit; a second end of the peak detection capacitor and a second end of the first resistor are both grounded.

As at least one alternative embodiment, the first detection circuit further includes a detection voltage follower, and the first end of the peak value detection capacitor is electrically connected to the input end of the comparison and amplification circuit by means of the detection voltage follower.

As at least one alternative embodiment, the first detection circuit includes a comparator; the comparator includes a first input end of electrically connected to the first excitation circuit and a second input end configured to input a preset detection reference voltage; the comparator is configured to output a square wave with a varying duty cycle according to a comparison of the first voltage signal output by the first excitation circuit and the preset detection reference voltage, wherein the duty cycle is proportional to the peak value of the first voltage signal; the first detection circuit further includes an active filter circuit or a mean value detection circuit; an output end of the comparator is connected to an input end of the active filter circuit or an input end of the mean value detection circuit; and an output end of the active filter circuit or an output end of the mean value detection circuit is electrically connected to the comparison and amplification circuit; the active filter circuit or the mean value detection circuit is configured to obtain a mean value of the square wave, wherein the mean value is proportional to the duty cycle of the square wave.

As at least one alternative embodiment, the liquid level measurement device further includes a first reference voltage circuit configured to provide the first preset reference voltage.

As at least one alternative embodiment, the first reference voltage circuit includes a reference voltage follower and a low-pass filter circuit; the low-pass filter circuit includes an output end connected to an input end of the reference voltage follower and an input end connected to a processing circuit; an output end of the reference voltage follower is electrically connected to the comparison and amplification circuit.

As at least one alternative embodiment, there are a plurality of low-pass filter circuits; an output end of the plurality of low-pass filter circuits after being connected in series is connected to the input end of the reference voltage follower; and an input end of the plurality of low-pass filter circuits after being connected in series is configured to be connected to the processing circuit.

As at least one alternative embodiment, the low-pass filter circuit includes a filter resistor and a filter capacitor; a first end of the filter resistor is the input end of the low-pass filter circuit; a second end of the filter resistor is electrically connected to a first end of the filter capacitor; the first end of the filter capacitor is the output end of the low-pass filter circuit; and a second end of the filter capacitor is grounded.

As at least one alternative embodiment, the first reference voltage circuit includes a DAC circuit; and an input end of the comparison and amplification circuit is connected to the DAC circuit.

As at least one alternative embodiment, the comparison and amplification circuit includes a fourth resistor, a fifth resistor, a sixth resistor, a seventh resistor and an operational amplifier; a non-inverting input end of the operational amplifier is connected to a first end of the fourth resistor and a first end of the sixth resistor; an inverting input end of the operational amplifier is connected to a first end of the fifth resistor and a first end of the seventh resistor; an output end of the operational amplifier is connected to a second end of the seventh resistor, and is configured to be connected to an MCU; a second end of the fourth resistor is connected to the first preset reference voltage; and a second end of the fifth resistor is connected to the output end of the first detection circuit; a second end of the sixth resistor is grounded.

As at least one alternative embodiment, the liquid level measurement device further includes: a second excitation circuit, configured to output a third voltage signal according to the input second excitation signal and the current liquid level, wherein an input end of the second excitation circuit is connected to an input end of the first excitation circuit; a second detection circuit, configured to extract a signal feature of the third voltage signal; a second reference voltage circuit; a subtraction circuit, wherein a first input end of the subtraction circuit is connected to an output end of the first detection circuit and an output end of the second detection circuit; a second input end of the subtraction circuit is connected to the second reference voltage circuit; and an output end of the subtraction circuit is connected to the input end of the comparison and amplification circuit; the subtraction circuit is configured to obtain a signal feature of a fourth voltage signal according to the signal feature of the first voltage signal, the signal feature of the third voltage signal and a second preset reference voltage provided by the second reference voltage circuit; the comparison and amplification circuit is configured to output a fifth voltage signal according to the signal feature of the first voltage signal, the signal feature of the fourth voltage signal and the first preset reference voltage.

As at least one alternative embodiment, the first excitation circuit includes a divider resistor; the sensitive element includes a first probe and a second probe which extend into the container, and a first detection capacitor is formed by the first probe and the second probe; the second probe is configured to contact a liquid at a first level; a first end of the first detection capacitor is grounded; a second end of the first detection capacitor is electrically connected to the first detection circuit and is electrically connected to a first end of the first divider resistor; and a second end of the first divider resistor is configured to receive the first excitation signal; or the first end of the first divider resistor is electrically connected to the first detection circuit and is electrically connected to a second end of the first detection capacitor; the second end of the first divider resistor is grounded;

the first end of the first detection capacitor is configured to receive the first excitation signal; the second excitation circuit includes a second divider resistor; the sensitive element includes the first probe and the third probe which extend into the container, and a second detection capacitor is formed by the first probe and a third probe; the third probe is configured to contact the liquid at a second liquid level; a resistance value of the second divider resistor is greater than a resistance value of the first divider resistor; the first liquid level is lower than the second liquid level; a first end of the second detection capacitor is grounded; a second end of the second detection capacitor is electrically connected to the first detection circuit and is electrically connected to a first end of the second divider resistor; and a second end of the second divider resistor is configured to receive the second excitation signal; or, a first end of the second divider resistor is electrically connected to the first detection circuit and is electrically connected to a second end of the second detection capacitor; the second end of the second divider resistor is grounded; and the first end of the second detection capacitor is configured to receive the second excitation signal.

As at least one alternative embodiment, the second reference voltage circuit includes a buck diode and a grounding resistor; a cathode of the buck diode is grounded by means of the grounding resistor; and an anode of the buck diode is configured to be connected to a reference power supply, and is configured to reduce a voltage of the reference power supply and output the second preset reference voltage.

As at least one alternative embodiment, since the processing assembly 103 is detachably connected to the detection assembly 102, and the processing assembly 103 is provided on the 3D printer body 201, the processing assembly 103 may be a corresponding processing circuit and a corresponding main controller; the main controller may collect the voltage converted by the detection assembly 102; and the actual liquid level height can be reflected by the voltage, thus completing the process of measuring the height of the resin liquid level.

According to the liquid level measurement device 100 and the 3D printer 300 provided in the embodiments of the present disclosure, during measurement, a detection assembly 102 may directly contact the resin for measurement, and the subsequent processing is achieved by means of a processing assembly 103 connected to the detection assembly 102.

As at least one alternative embodiment, as the detection assembly 102 is detachably connected to the processing assembly 103, this design may detach the detection assembly 102 along with the material tray frame for replacement after each detection, thereby avoiding the problem of mutual contamination between different resins, and also having the advantage of high convenience. As at least one alternative embodiment, the material tray may be a disposable material tray, and the detection assembly and the material tray may be discarded together after being used.

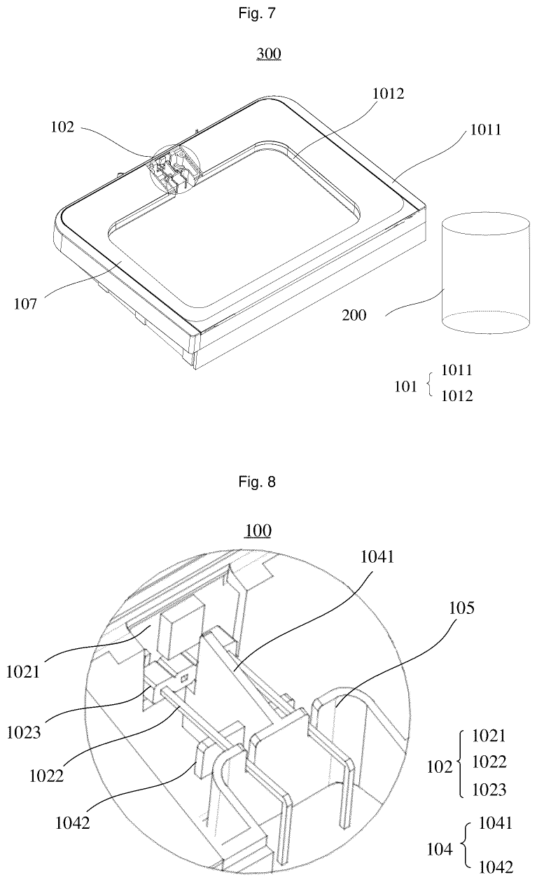

Referring to FIGS. 7, 8 and 9, in an optional embodiment, the detection assembly 102 includes a first detection chip 1021 and a plurality of sensitive elements 1022;
the first detection chip 1021 is provided in the material tray frame 101 or on the 3D printer body 201, and is connected to the first connection structure;
Each of the sensitive elements 1022, after being mounted to a probe mounting member, is detachably connected or fixedly connected to the first detection chip 1021, and each of the sensitive elements 1022 extends into the liquid storage area of the material tray frame 101. The first detection chip includes the first detection circuit, which can be configured to perform primary processing on an electrical signal transmitted by the sensitive element.

The designed first detection chip 1021 may be provided in the material tray frame 101. For example, as shown in FIG. 6, the first detection chip 1021 (not shown in FIG. 6) of the detection assembly 102 is provided at the side wall of the material tray frame 101.

For example, the material tray frame 101 may be provided with an opening on the side wall, a contact (at the processing assembly 103 as shown in FIG. 5) may be provided on the 3D printer body, and the contact is connected to the processing assembly 103, so as to establish an electrical connection between the first detection chip and the processing component 103 after the contact point of the first detection chip contacts the contact.

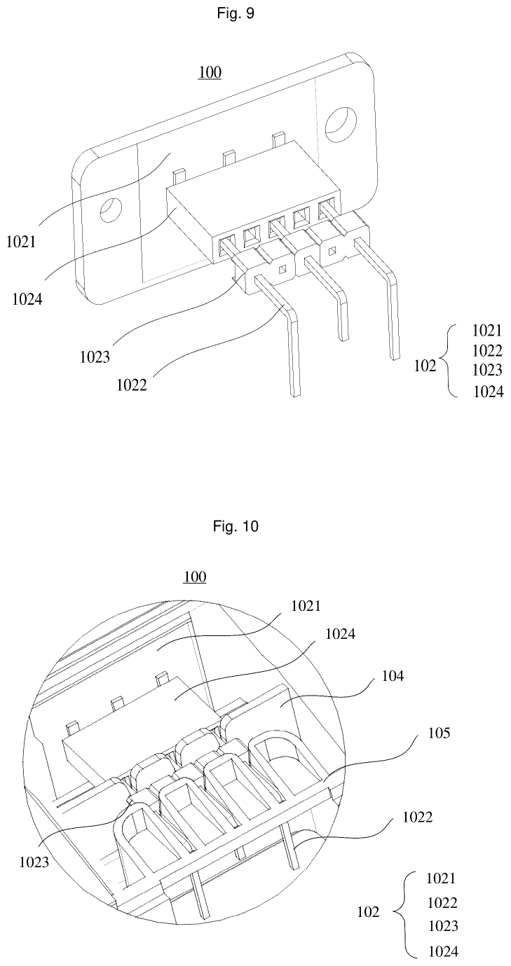

In a specific example, the sensitive element 1022 includes a probe which is designed to contact the resin contained in the material tray frame 101, and thus the structure of the probe may be designed to be bent. For example, as shown in FIGS. 8 and 9, each probe may be designed with a bent portion, and the bent portion of each probe may be arranged perpendicular to the direction of the inner bottom wall of the material tray frame 101, which facilitates the bent portion of the probe to contact the resin in the material tray frame 101. In order to make the probe contact with the resin contained in the material tray frame 101, the probe may also be arranged as other structures, which is not specifically limited in the embodiments of the present disclosure.

In the embodiments of the present disclosure, each sensitive element 1022 in the detection assembly 102 is detachably or fixedly connected to the first detection chip 1021, with such a design, when the first detection chip is provided on the 3D printer body, after each detection, the sensitive element 1022 is detached from the first detection chip 1021 and replaced, or when the first detection chip is provided on the material tray frame, the whole detection assembly 102 is detached from its detachable connection position with the processing component 103 and replaced. As at least one alternative embodiment, a liquid level measurement element (not shown in the figure) is provided in the first detection chip 1021, and the liquid level measurement element is connected to each sensitive element 1022.

In the embodiments of the present disclosure, the liquid level measurement element provided in the first detection chip 1021 is configured to convert a change of the equivalent capacitance of the sensitive element 1022 during the measurement into a change of the voltage. Therefore, the designed level measurement element may be a circuit that converts the equivalent capacitance of the sensitive element 1022 into a direct-current voltage. For example, the liquid level measurement element may be a combination of an excitation circuit and a peak detection circuit or a combination of other conventional circuits; and the processing assembly 103, which is designed on the basis of the direct-current voltage value and connected electrically subsequently, is configured to calculate the liquid level measurement result.

As at least one alternative embodiment, the processing assembly 103 includes a second detection chip and a controller (not shown).

The second detection chip and the controller are both provided on the 3D printer body 201, and the second detection chip is connected to the controller. This setting is used to calculate the liquid level measurement result.

As at least one alternative embodiment, as shown in FIG. 7, the material tray frame 101 includes a material tray outer frame 1011 and a material tray inner frame 1012; the material tray outer frame 1011 and the material tray inner frame 1012 are connected by means of a material tray bottom wall (not shown in the figure); an accommodating cavity (not shown in the figure) is formed between the material tray outer frame 1011 and the material tray inner frame 1012; and both the first detection chip 1021 and the sensitive elements 1022 are provided in the accommodating cavity. The provided accommodating cavity makes the arrangements of the first detection chip 1021 and the sensitive element 1022 more reasonable.

Please refer to FIGS. 8 and 10, as at least one alternative embodiment, a fixing assembly is further provided in the accommodating cavity, and the fixing assembly includes a first bearing member 104 and a second bearing member 105.

Each of the sensitive elements 1022 is placed on the first bearing member 104 and the second bearing member 105; and one end of each of the sensitive elements extends into the liquid storage area of the material tray inner frame 1012. This arrangement is configured to place each of the sensitive elements 1022, so as to further secure each of the sensitive elements 1022 from any movement.

Please refer to FIG. 8, as at least one alternative embodiment, the first bearing member 104 includes a partition plate 1041 and placement members 1042, wherein the partition plate 1041 is provided in the accommodating cavity and separates the accommodating cavity, and the placement members 1042 are respectively provided at two sides of the partition plate 1041.

The second bearing member 105 is provided with a plurality of grooves (not shown in the figure); the positions of the grooves correspond to the positions of the sensitive elements 1022 on a one-to-one basis; and each of the sensitive elements 1022 is placed in the placement member 1042 and grooves at the corresponding positions and then extends into the liquid storage area of the material tray inner frame 1012. It should be noted that the sensitive element includes a rubber core 1023 and a probe that passes through the rubber core 1023.

Exemplarily, as shown in FIG. 8, the first bearing member 104 and the second bearing member 105 may be integrally formed with the material tray inner frame 1012; the second bearing member 105 may be designed as a frame structure protruding in the direction of the material tray outer frame 1011; the first bearing member 104 and the second bearing member 105 are both configured to fixing the sensitive elements 1022; and the sensitive element on the second bearing member 105 also has a certain limiting effect on the sensitive elements 1022. The placement member 1042 of the first bearing member 104 bears the extending portion of the sensitive element 1022, so that the sensitive element 1022 is not completely suspended; the portion of the sensitive element 1022 extending out of the placement member 1042 will be borne by the second bearing member 105, so that the whole sensitive element 1022 is stably arranged; and the sensitive elements 1022 are placed in the grooves of the second bearing member 105, thereby preventing the whole of the sensitive elements 1022 from moving left and right during use.

Referring to FIGS. 9 and 10, as at least one alternative embodiment, the detection assembly includes the first detection chip 1021, the sensitive elements 1022, a rubber core 1023, and a female header socket 1024. The sensitive elements 1022 passes through the rubber core 1023 and the female header socket 1024 in sequence and then are connected to the first detection chip 1021.

The first bearing member 104 is a bearing plate; a plurality of grooves (not shown in the figure) are provided on the bearing plate; and the number of the grooves corresponds to the number of the sensitive elements 1022.

The second bearing member 105 is provided with a plurality of channels and a plurality of through holes (not shown in the figure); and the number of the channels and the number of the through holes correspond to the number of the sensitive elements 1022.

The sensitive elements 1022 are sequentially placed in the grooves corresponding to the first bearing member 104 and the channels corresponding to the second bearing member 105, and extend into the liquid storage area of the material tray inner frame 1012 by means of through holes.

Exemplarily, as shown in FIG. 10, the first bearing member 104 may be designed as a bearing plate and is provided between the second bearing member 105 and the female header socket; the second bearing member 105 may be integrally formed with the material tray inner frame 1012; and the second bearing member 105 may be designed as a frame structure protruding in a direction of the material tray outer frame 1011. The first bearing member 104 and the second bearing member 105 are both configured to fix the sensitive elements 1022; and the grooves on the first bearing member 104 and the channels on the second bearing member 105 also have a certain limiting effect on the sensitive elements 1022. After the sensitive elements 1022 are provided in the rubber core 1023 and a busbar, the grooves of the first bearing member 104 and the channels of the second bearing member 105 bear the extending portions of the sensitive elements 1022, so that the sensitive elements 1022 are stably arranged as a whole, and the sensitive elements 1022 extend into the liquid storage area of the material tray inner frame 1012 by means of the through holes of the second bearing member 105 to contact the resin. An accommodating area for accommodating the rubber core 1023 is further provided between the first bearing member and the second bearing member.

As at least one alternative embodiment, a material tray cover 107 is provided on an end face between the material tray outer frame 1011 and the material tray inner frame 1012, and a plurality of limiting members 106 are provided on the material tray cover 107. Each of the limiting members is configured to cooperate with the first bearing member and the second bearing member, so as to limit the position of each of the sensitive elements.

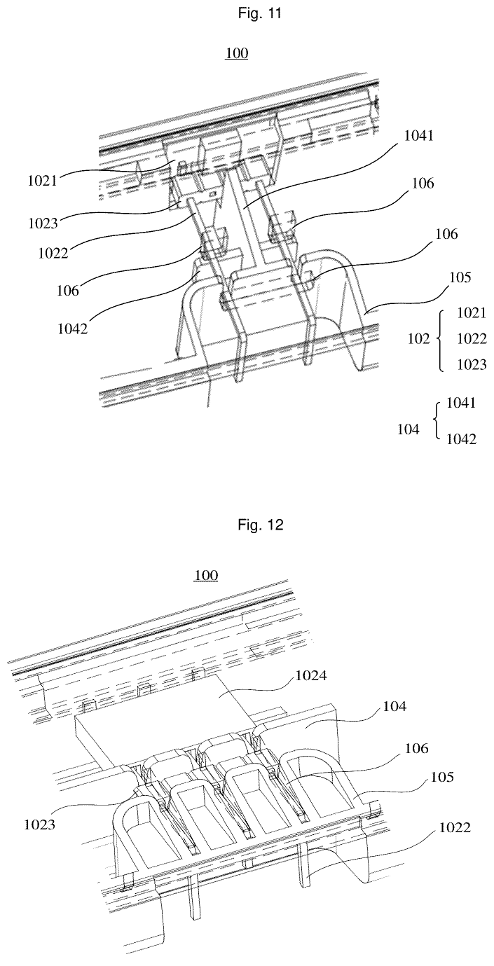

As shown in FIG. 11, the limiting members 106 are provided between the sensitive elements 1022 at the first bearing member 104 and the second bearing member 105 and the material tray cover 107.

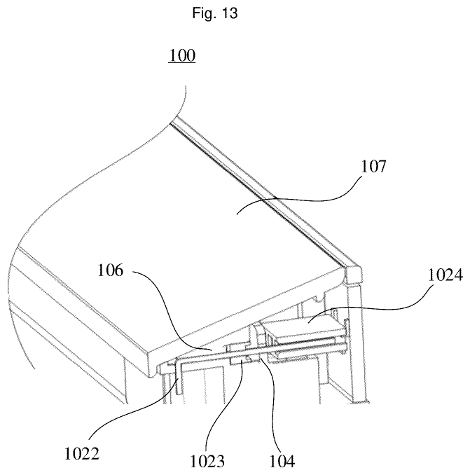

Alternatively, as shown in FIGS. 12 and 13, one end of each of the limiting members 106 is provided between each sensitive element 1022 at the first bearing member 104 and the material tray cover 107, and the other end of each of the limiting members is provided between each sensitive element 1022 at the second bearing member 105 and the material tray cover 107 (not shown in the figures). The plurality of limiting members 106 are configured to limit the whole of the sensitive elements 1022.

It should be noted that, as the sensitive elements 1022 are configured to form an equivalent capacitor, the number of sensitive elements 1022 may be two or more (for example, the number of sensitive elements 1022 is three, four, etc.); and in this case, the number of grooves or channels may be correspondingly increased by the first bearing member 104 and the second bearing member 105 of the installing assembly of the sensitive elements 1022 according to the number of sensitive elements 1022.

Exemplarily, in cases where there are two sensitive elements 1022, the design of the limiting member 106 may be as shown in FIG. 11; the limiting member 106 may be provided between the sensitive elements 1022 at the first bearing member 104 and the second bearing member 105 and the material tray cover 107, to cooperate with the first bearing member 104 and the second bearing member 105 at corresponding positions, so as to limit the sensitive elements 1022 in the height direction of the material tray frame 101.

In cases where there are a plurality of sensitive elements 1022 (for example, there are three sensitive elements 1022), the design of the limiting member 106 may be as shown in FIGS. 12 and 13; one end of the limiting member 106 may be provided between the sensitive elements 1022 at the first bearing member 104 and the material tray cover 107, and the other end of the limiting member is provided between the sensitive elements 1022 at the second bearing member 105 and the material tray cover 107, to cooperate with the first bearing member 104 and the second bearing member 105 to limit the sensitive elements 1022 in the height direction of the material tray frame 101.

The limiting member 106 and the bearing members can secure the sensitive elements 1022, preventing displacement of the sensitive elements in any direction, thereby enabling the sensitive elements 1022 to have high stability; the structure also has the advantage of strong manufacturability, enabling easy, consistent, and high-quality production, avoiding detection errors due to inconsistencies in sensitive elements 1022 in large-scale products.

As at least one alternative embodiment, to avoid the detection inaccuracy caused by temperature, material and the like when using two sensitive elements 1022 to measure the liquid level, it may be set that the distance between the end of the third sensitive element 1022 in contact with the resin and the bottom wall of the material tray is equal to the highest liquid level value of the material tray frame 101; when the liquid level rises and the resin begins to cover the third sensitive element 1022, the equivalent capacitance formed by the sensitive elements 1022 will undergo a sudden change; when the capacitance changes suddenly, it indicates that the resin liquid level has reached the upper limit in this case, and resin addition may be stopped in this case.

The embodiments of the present disclosure further provide a 3D printer 300; the 3D printer 300 includes a resin bottle assembly 200, a 3D printer body 201, and the liquid level measurement device 100 according to any one of the foregoing embodiments.

The resin bottle assembly 200 is snapped-fitted onto an outer wall of a material tray frame 101 of the liquid level measurement device 100. The specific snapped-fitting manner is not limited, and snapped-fitting is not shown in the figure.

A sliding groove (not shown in the figure) is provided on an inner side wall of the 3D printer body 201, and the material tray frame 101 of the liquid level measurement device 100 is slidably provided at the sliding groove.

The provided resin bottle assembly 200 is configured to storing resin, and injecting the resin into the material tray frame 101 of the liquid level measurement device 100 when performing detection; and the 3D printer body 201 is configured to cooperating with the liquid level measurement device 100 to achieve data calculation of liquid level measurement.

The liquid level measurement device 100 and the 3D printer provided in the present disclosure have the following beneficial effects: during measurement, a detection assembly can directly contact the resin for measurement, and the subsequent processing is achieved by means of a processing assembly connected to the detection assembly. As at least one alternative embodiment, as the detection assembly is detachably connected to the processing assembly, the detection assembly can be replaced together with the processing assembly when replacing the material tray frame after each detection, thereby solving the problem of mutual contamination between different resins while achieving liquid level measurement.

In general, the present disclosure proposes a liquid level measurement device, a liquid level measurement method, a liquid level measurement apparatus, a storage medium, and a 3D printer. Signals generated by detection are compared with a reference voltage and amplified, so that a liquid level height is calculated, the occupied volume is small, and the measurement precision is high.

The apparatus and system embodiments described above are merely exemplary, and a part or all of the modules may be selected according to actual needs to achieve the objectives of the solutions of the embodiments. A person of ordinary skill in the art can understand and implement the present invention without inventive efforts.

The foregoing descriptions are merely preferable specific embodiments of the present disclosure, and the scope of protection of the present disclosure is not limited thereto. A person skilled in the art would have readily conceived of variations or replacements within the technical scope disclosed in the present disclosure, and the variations or replacements shall all belong to the scope of protection of the present disclosure. Thus, the scope of protection of the present disclosure shall be subject to the scope of protection of the claims.

### INDUSTRIAL APPLICABILITY

The solution provided by the embodiments of the present disclosure can be applied to the technical field of liquid level measurement. In the embodiments of the present disclosure, a probe-type resin liquid level measurement device based on a capacitance variation is used, and a first excitation circuit is configured to output a first voltage signal according to an input first excitation signal and a current liquid level; a first detection circuit is configured to extract a signal feature of the first voltage signal; a comparison and amplification circuit is configured to output a second voltage signal according to the signal feature of the first voltage signal and a first preset reference voltage, thereby achieving the technical effect of providing a liquid level measurement device with a small volume, high measurement precision, low construction cost and high practicability.

What is claimed is:

1. A liquid level measurement device of a 3D printing device, comprising:
a first excitation circuit, configured to output a first voltage signal according to an input first excitation signal and a current liquid level of an object to be measured;
a first detection circuit, configured to extract a signal feature of the first voltage signal, wherein the signal feature comprises at least one of a peak value, a peak-to-peak value, or a minimum value; and
a comparison and amplification circuit, configured to output a second voltage signal according to the signal feature and a first preset reference voltage, wherein the second voltage signal is configured to represent a height corresponding to the current liquid level,
wherein the first excitation circuit comprises a detection capacitor, and an equivalent capacitance of the detection capacitor is associated with the current liquid level of the object to be measured.

2. The liquid level measurement device as claimed in claim 1, wherein the detection capacitor comprises at least two probes.

3. The liquid level measurement device as claimed in claim 1, wherein the first excitation circuit further comprises an excitation voltage follower; and
an output end of the excitation voltage follower is electrically connected to the input end of the first detection circuit, and an input end of the excitation voltage follower is connected to the detection capacitor.

4. The liquid level measurement device as claimed in claim 1, wherein the first excitation circuit further comprises a divider resistor, a voltage of the divider resistor is associated with the current liquid level of the object to be measured.

5. The liquid level measurement device as claimed in claim 1, further comprising:
a first reference voltage circuit, configured to provide the first preset reference voltage.

6. The liquid level measurement device as claimed in claim 1, wherein the liquid level measurement device further comprises:
a second excitation circuit, configured to output a third voltage signal according to an input second excitation signal and the current liquid level of the object to be measured, wherein an input end of the second excitation circuit is connected to an input end of the first excitation circuit;
a second detection circuit, configured to extract a signal feature of the third voltage signal;
a second reference voltage circuit;
a subtraction circuit, wherein a first input end of the subtraction circuit is connected to an output end of the first detection circuit and an output end of the second detection circuit; a second input end of the subtraction circuit is connected to the second reference voltage circuit; and an output end of the subtraction circuit is connected to an input end of the comparison and amplification circuit; the subtraction circuit is configured to obtain a signal feature of a fourth voltage signal according to the signal feature of the first voltage signal, the signal feature of the third voltage signal and a second preset reference voltage provided by the second reference voltage circuit; and
the comparison and amplification circuit is configured to output a fifth voltage signal according to the signal feature of the first voltage signal, the signal feature of the fourth voltage signal and the first preset reference voltage.

7. The liquid level measurement device as claimed in claim 6, wherein the first excitation circuit comprises a first detection capacitor and a first divider resistor; the first detection capacitor is formed by a first probe and a second probe which extend into a container; the second probe is configured to contact a liquid at a first liquid level;
a first end of the first detection capacitor is grounded; a second end of the first detection capacitor is electrically connected to the first detection circuit and is electrically connected to a first end of the first divider resistor; and a second end of the first divider resistor is configured to receive the first excitation signal; or the first end of the first divider resistor is electrically connected to the first detection circuit and is electrically connected to a second end of the first detection capacitor; the second end of the first divider resistor is grounded; the first end of the first detection capacitor is configured to receive the first excitation signal;
the second excitation circuit comprises a second detection capacitor and a second divider resistor; the second detection capacitor is formed by the first probe and a third probe; the third probe is configured to contact the liquid at a second liquid level; a resistance value of the second divider resistor is greater than a resistance value of the first divider resistor; the first liquid level is lower than the second liquid level;
a first end of the second detection capacitor is grounded; a second end of the second detection capacitor is electrically connected to the first detection circuit and is electrically connected to a first end of the second divider resistor; and a second end of the second divider resistor is configured to receive the second excitation signal; or, a first end of the second divider resistor is electrically connected to the first detection circuit and is electrically connected to the second end of the second detection capacitor; the second end of the second divider resistor is grounded; and the first end of the second detection capacitor is configured to be connected to the second excitation signal.

8. A 3D printing device, comprising:
a material tray; and
a liquid level measurement device comprising:
a first excitation circuit, wherein the first excitation circuit comprises a detection capacitor, an equivalent capacitance of the detection capacitor is associated with a current liquid level of the material tray, and the first excitation circuit is configured to output a first voltage signal at least based on the equivalent capacitance of the detection capacitor;
a first detection circuit configured to extract a signal feature from the first voltage signal; and
a comparison and amplification circuit configured to output an amplified second voltage signal at least based on the signal feature of the first voltage signal.

9. The 3D printing device as claimed in claim 8, wherein the detection capacitor comprises a first probe and a second probe that extend into the material tray, and the equivalent capacitance of the detection capacitor is associated with a dielectric constant of a medium between the first probe and the second probe.

10. The 3D printing device as claimed in claim 9, further comprising a second excitation circuit, wherein a detection capacitor of the second excitation circuit comprises a third probe, and an equivalent capacitance of the detection capacitor of the second excitation circuit is associated with a dielectric constant of a medium between the third probe and the first probe of the first excitation circuit, wherein a liquid level of the second probe is lower than a liquid level of the third probe.

11. The 3D printing device as claimed in claim 9, wherein the first probe and the second probe of the detection capacitor of the first excitation circuit are fixed to the material tray.

12. The 3D printing device as claimed in claim 8, wherein the first excitation circuit further comprises a divider resistor,
wherein the detection capacitor of the first excitation circuit is connected to the first detection circuit and the divider resistor, wherein the divider resistor is configured to receive a first excitation signal; or
the divider resistor of the first excitation circuit is connected to the first detection circuit and the detection capacitor, wherein the detection capacitor is configured to receive a first excitation signal.

13. The 3D printing device as claimed in claim 12, wherein the first excitation circuit further comprises an excitation voltage follower, an output end of the excitation voltage follower is electrically connected to an input end of the first detection circuit, and an input end of the excitation voltage follower is connected to a connection point of the detection capacitor and the divider resistor.

14. The 3D printing device as claimed in claim 8, wherein the first detection circuit comprises a comparator configured to output a square wave with a variable duty cycle at least according to a comparison of the first voltage signal and a preset detection reference voltage, wherein the duty cycle is proportional to a peak value of the first voltage signal;
the detection circuit further comprises an active filter circuit or a mean value detection circuit, wherein the active filter circuit or the mean value detection circuit is configured to obtain a mean value of the square wave, and the mean value is proportional to the duty cycle of the square wave.

15. The 3D printing device as claimed in claim 8, wherein the liquid level measurement device further comprises a first reference voltage circuit, wherein the first reference voltage circuit is configured to provide a first preset reference voltage, and the comparison and amplification circuit is configured to output the second voltage signal according to the signal feature of the first voltage signal and the first preset reference voltage.

16. The 3D printing device as claimed in claim 15, wherein the first reference voltage circuit comprises a reference voltage follower and a low-pass filter circuit.

17. The 3D printing device as claimed in claim 8, wherein the liquid level measurement device further comprises:
a second excitation circuit, configured to output a third voltage signal according to an input second excitation signal and the current liquid level, wherein an input end of the second excitation circuit is connected to an input end of the first excitation circuit;
a second detection circuit, configured to extract a signal feature of the third voltage signal;
a second reference voltage circuit; and
a subtraction circuit, wherein a first input end of the subtraction circuit is connected to an output end of the first detection circuit and an output end of the second detection circuit; a second input end of the subtraction circuit is connected to the second reference voltage circuit; and an output end of the subtraction circuit is connected to an input end of the comparison and amplification circuit; the subtraction circuit is configured to obtain a signal feature of a fourth voltage signal according to the signal feature of the first voltage signal, the signal feature of the third voltage signal and a second preset reference voltage provided by the second reference voltage circuit,
wherein the comparison and amplification circuit is configured to output a fifth voltage signal according to the signal feature of the first voltage signal, the signal feature of the fourth voltage signal and the first preset reference voltage.

18. A method for detecting a liquid level of a material tray in a 3D printing device, comprising:
outputting a first voltage signal by a first excitation circuit of a liquid level measurement device of the 3d printing device, wherein an equivalent capacitance of a detection capacitor of the first excitation circuit is associated with a current liquid level of the material tray;
extracting a signal feature from the first voltage signal by a detection circuit of the liquid level measurement device;
outputting an amplified second voltage signal at least based on the signal feature of the first voltage signal by a comparison and amplification circuit of the liquid level measurement device; and
determining the current liquid level of the material tray based on the second voltage signal.

19. The method as claimed in claim 18, further comprising:
determining that the current liquid level of the material tray has reached a predetermined liquid level by a second excitation circuit of the liquid level measurement device; and
providing a warning,
wherein the detection capacitor of the first excitation circuit comprises at least a second probe, a detection capacitor of the second excitation circuit comprises at least a third probe, where a liquid level of the second probe is lower than a liquid level of the third probe, and the predetermined liquid level is determined by the liquid level of the third probe.

20. The method as claimed in claim 18, further comprising:
acquiring the second voltage signal;
determining that zeroing is successful when a voltage value associated with the second voltage signal falls within a preset range;
reading a current second voltage signal and/or a current temperature signal according to a received liquid reading instruction; and
obtaining a current liquid level based on the current second voltage signal and/or the current temperature signal.
